(19) United States
(12) Patent Application Publication
(10) Pub. No.: US 2007/0211283 A1
(43) Pub. Date: Sep. 13, 2007

(54) Image processing apparatus

(75) Inventor: Tomokazu Hoshino, Tokyo (JP)

Correspondence Address: TAKEUCHI & KUBOTERA, LLP, SUITE 202, 200 DAINGERFIELD ROAD, ALEXANDRIA, VA, 22314, US

(73) Assignee: Oki Data Corporation

(21) Appl. No.: 11/708,487

(22) Filed: Feb. 21, 2007

(30) Foreign Application Priority Data
Mar. 13, 2006 (JP) 2006-066885

(51) Int. Cl. G06F 3/12

(52) U.S. Cl. 358/1.15

(57) ABSTRACT

An image processing apparatus includes a receiving unit for receiving image data including graphic data and hatching specifying data; a data analyzing unit for analyzing the image data to detect the hatching specifying data; a pattern forming unit for forming a hatching pattern according to the hatching specifying data when the data analyzing unit detects the hatching specifying data; a pattern arranging unit for arranging the hatching pattern formed by the pattern forming unit with respect to a standard point of a page; and a clip processing unit for clipping the hatching pattern arranged by the pattern arranging unit according to the image data.

### BACKGROUND OF THE INVENTION

The present invention relates to an image processing apparatus, in particular, an image processing apparatus capable of generating hatching data in a specific way.

A conventional image processing apparatus generates hatching data for drawing hatching lines. When hatching lines with a specified angle and a specified interval are drawn in a specific area, crossing points of the hatching lines with respect to a boundary of the specific area are calculated, so that the hatching lines are drawn between the crossing points (refer to Patent Reference).

### Patent Reference: Japanese Patent Publication No. 08-185530

In the conventional image processing apparatus, a line width is not taken into consideration in drawing the hatching lines. Accordingly, when hatching lines having a large line width are drawn, the hatching lines may run over or run short with respect to a boundary of a specific area at crossing points thereof.

More specifically, FIGS. 2(a) to 2(c) are schematic views showing an example of hatching lines drawn with a conventional image processing apparatus. FIG. 2(a) is a view showing a specific area in which the hatching lines are supposed to be drawn. FIG. 2(b) is a view showing a case that the hatching lines having a small line width are drawn in the specific area. FIG. 2(c) is a view showing a case that the hatching lines having a large line width are drawn in the specific area.

As shown in FIG. 2(b), when the hatching lines having a small line width (for example, one dot) are drawn in the specific area shown in FIG. 2(a), crossing points between the hatching lines and a boundary of the specific area are drawn with no blemish. In contrast, as shown in FIG. 2(c), when the hatching lines having a large line width (for example, 13 dot) are drawn in the specific area, the hatching lines run over or run short with respect to the boundary of the specific area at the crossing points thereof. This is because, when the hatching lines are drawn, centerlines thereof are drawn first, and then the hatching lines are enlarged in a direction perpendicular to the centerlines.

In view of the problems described above, an object of the present invention is to provide an image processing apparatus capable of solving the problems of the conventional image processing apparatus. In particular, when the image processing apparatus of the present invention draws hatching lines, a hatching pattern is clipped. Accordingly, it is possible to draw the hatching lines along a boundary of a specific area without ends of the hatching lines running over or running short with respect to the boundary of the specific area at crossing points of the hatching lines.

Further objects and advantages of the invention will be apparent from the following description of the invention.

### SUMMARY OF THE INVENTION

In order to attain the objects described above, according to the present invention, an image processing apparatus comprises a receiving unit for receiving image data including graphic data and hatching specifying data; a data analyzing unit for analyzing the image data to detect the hatching specifying data; a pattern forming unit for forming a hatching pattern according to the hatching specifying data when the data analyzing unit detects the hatching specifying data; a pattern arranging unit for arranging the hatching pattern formed by the pattern forming unit with respect to a standard point of a page; and a clip processing unit for clipping the hatching pattern arranged by the pattern arranging unit according to the image data.

In the present invention, as described above, when the image processing apparatus draws the hatching lines, the hatching pattern is clipped. Accordingly, it is possible to draw the hatching lines along a boundary of a graphic or specific area without ends of the hatching lines running over or running short with respect to the boundary of the specific area at crossing points of the hatching lines.

### BRIEF DESCRIPTION OF THE DRAWINGS

FIG. 1 is a block diagram showing a configuration of an image processing apparatus according to a first embodiment of the present invention;

FIGS. 2(a) to 2(c) are schematic views showing an example of hatching lines drawn with a conventional image processing apparatus, wherein FIG. 2(a) is a view showing a specific area in which the hatching lines are supposed to be drawn, FIG. 2(b) is a view showing a case that the hatching lines having a small line width are drawn in the specific area, and FIG. 2(c) is a view showing a case that the hatching lines having a large line width are drawn in the specific area;

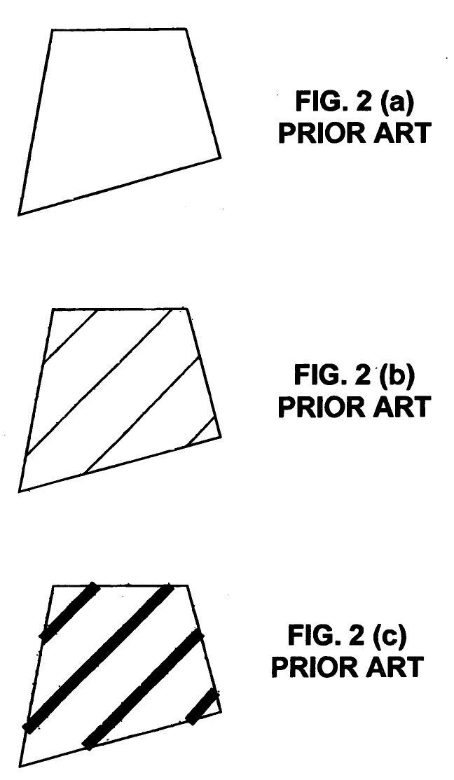

FIGS. 3(a) and 3(b) are views showing an operation of pattern processing according to the first embodiment of the present invention, wherein FIG. 3(a) is a view showing a method of calculating a cycle of a pattern, and FIG. 3(b) is a view showing a method of forming the pattern;

FIGS. 4(a) to 4(f) are views showing an example of hatching lines using the pattern according to the first embodiment of the present invention, wherein FIG. 4(a) is a view showing a graphic in which hatching is applied; FIG. 4(b) is a view showing an example of the hatching pattern; FIG. 4(c) is a view showing an example in which the hatching pattern is laid out; FIG. 4(d) is a view showing a method of setting a range in which the hatching pattern is laid out; FIG. 4(e) is a view showing an operation of a deploying process; and FIG. 4(f) is a view showing the graphic after hatching is applied;

FIG. 5 is a flow chart showing an operation of a data editing unit and a data deploying unit according to the first embodiment of the present invention;

FIG. 6 is a flow chart showing a subroutine of the pattern processing according to the first embodiment of the present invention;

FIG. 7 is a block diagram showing a configuration of an image processing apparatus according to a second embodiment of the present invention;

FIGS. 8(a) to 8(d) are views showing comparative examples of hatching lines, wherein FIG. 8(a) is a view showing a first comparative example of the hatching lines, FIG. 8(b) is a view showing a pattern to be created in the first comparative example, FIG. 8(c) is a view showing a second comparative example of the hatching lines, and FIG. 8(d) is a view showing a pattern to be created in the second comparative example;

FIGS. 9(a) and 9(d) are schematic views showing clips according to the second embodiment of the present invention, wherein FIG. 9(a) is a view showing an example of a rectangular clip, FIG. 9(b) is a view showing a print result of the rectangular clip, FIG. 9(c) is a view showing an example of a polygonal clip, FIG. 9(d) is a view showing a print result of the polygonal clip, FIG. 9(e) is a view showing an example of a circular clip, and FIG. 9(f) is a view showing a print result of the circular clip;

FIGS. 10(a) to 10(c) are views showing an example of hatching lines using a graphic as a clip according to the second embodiment of the present invention, wherein FIG. 10(a) is a view showing a rectangular shape in which the graphic is accommodated, FIG. 10(b) is a view showing a state that hatching is applied to the rectangular shape, and FIG. 10(c) is a view showing a print result after hatching is applied;

FIG. 11 is a view showing a method of determining a size of a rectangle according to the second embodiment of the present invention; and

FIG. 12 is a flow chart showing an operation of a data editing unit and a data deploying unit according to the second embodiment of the present invention.

### DETAILED DESCRIPTION OF THE PREFERRED EMBODIMENTS

Hereunder, embodiments of the present invention will be explained with reference to the accompanying drawings.

### First Embodiment

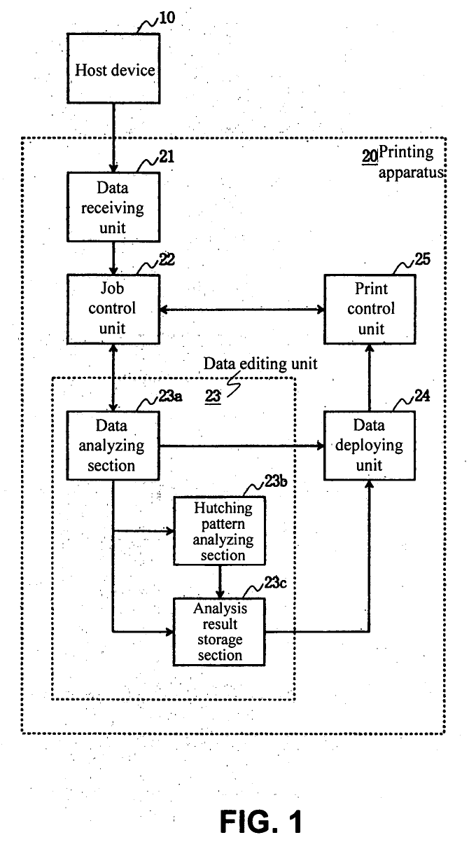

A first embodiment of the present invention will be explained. FIG. 1 is a block diagram showing a configuration of an image processing apparatus according to the first embodiment of the present invention.

As shown in FIG. 1, the image forming apparatus or a printing apparatus 20 as an image forming apparatus is connected to a host device 10 through a communication path such as an interface cable, a network, and the likes. In the embodiment, the printing apparatus 20 includes ink-jet type printer, an electric-photography type printer, a copier, a facsimile, and the likes, and may include any types of printing apparatus. Further, the printing apparatus 20 may form a monochrome image or a color image.

In the embodiment, the host device 10 is a computer such as a personal computer, a server, and the likes having an operation device such as a CPU, an MPU, and the likes; a storage device such as a hard disk, a semiconductor memory, and the likes; an input device such as a keyboard, a mouse, a touch panel, and the likes; and a display device such as a CRT, a liquid crystal display, and the likes. Further, the host device 10 may include a device capable of generating print data that enables the printing apparatus 20 to perform a printing operation.

In the embodiment, the printing apparatus 20 includes a data receiving unit 21 as a receiving unit; a job control unit 22; a data editing unit 23; a data deploying unit 24 as a pattern arranging unit or clip processing unit; and a print control unit 25. The data editing unit 23 includes a data analyzing section 23a; a hatching pattern analyzing section 23b as a pattern forming unit; and an analysis result storage section 23c.

In the embodiment, the data receiving unit 21 receives print data sent from the host device 10, and sends the print data to the job control unit 22. Further, the job control unit 22 controls the data editing unit 23 to edit the print data sent from the data receiving unit 21, and sends a command to the print control unit 25 for performing a printing operation. The data analyzing section 23a of the data editing unit 23 analyzes the print data thus received.

When hatching is applied, the hatching pattern analyzing section 23b generates pattern data according to a specified hatching angle, an interval between lines, and a line width. The analysis result storage section 23c stores an analysis result of the print data created by the data analyzing section 23a and the pattern data of hatching created by the hatching pattern analyzing section 23b.

In the embodiment, the data deploying unit 24 receives the analysis result and the pattern data of hatching thus created from the analysis result storage section 23c, and generates print image data to be sent to the print control unit 25 according to the analysis result and the pattern data of hatching. The print control unit 25 performs the printing operation of the print image data received from the data deploying unit 24.

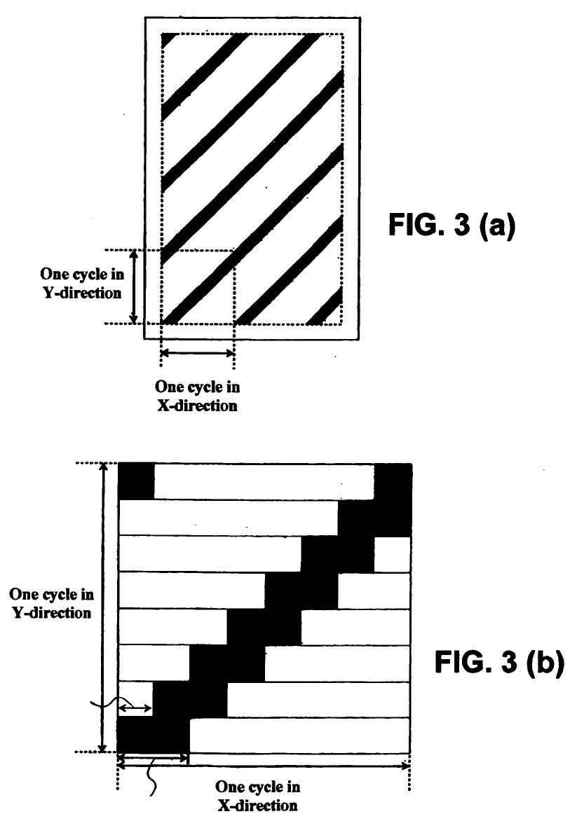

An operation of the printing apparatus 20 will be explained next. FIGS. 3(a) and 3(b) are views showing an operation of pattern processing according to the first embodiment of the present invention. More specifically, FIG. 3(a) is a view showing a method of calculating a cycle of a pattern, and FIG. 3(b) is a view showing a method of forming the pattern.

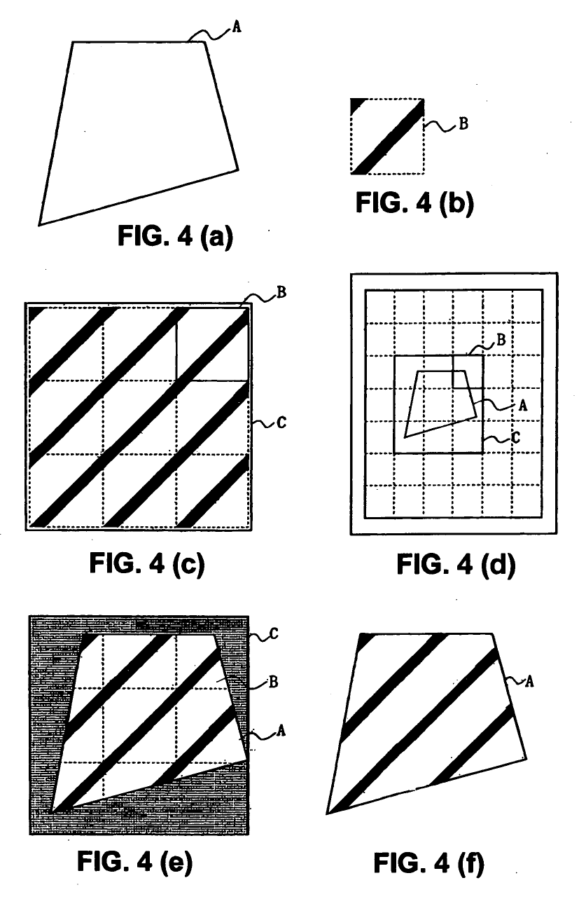

FIGS. 4(a) to 4(f) are views showing an example of hatching lines using a pattern according to the first embodiment of the present invention. More specifically, FIG. 4(a) is a view showing a graphic in which hatching is applied; FIG. 4(b) is a view showing an example of a hatching pattern; FIG. 4(c) is a view showing an example in which the hatching pattern is laid out; FIG. 4(d) is a view showing a method of setting a range in which the hatching pattern is laid out; FIG. 4(e) is a view showing an operation of a deploying process; and FIG. 4(f) is a view showing the graphic after hatching is applied.

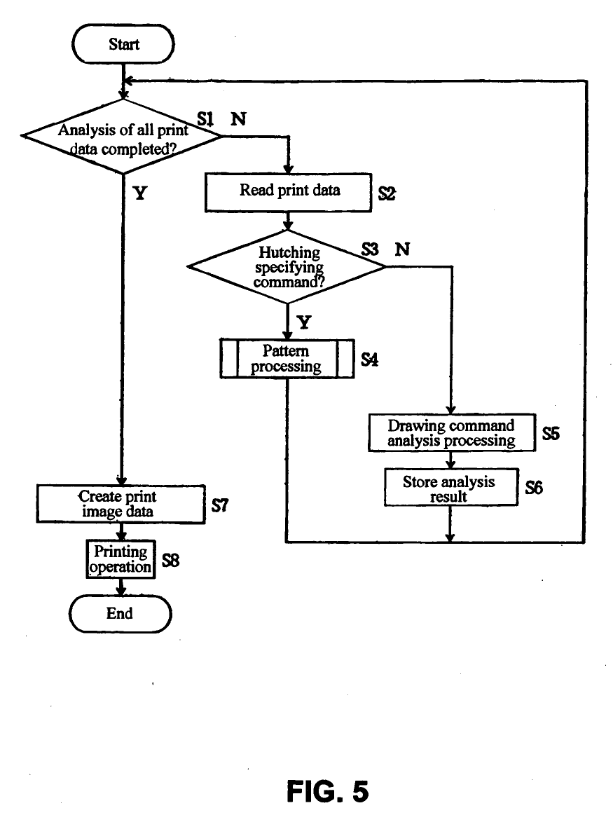

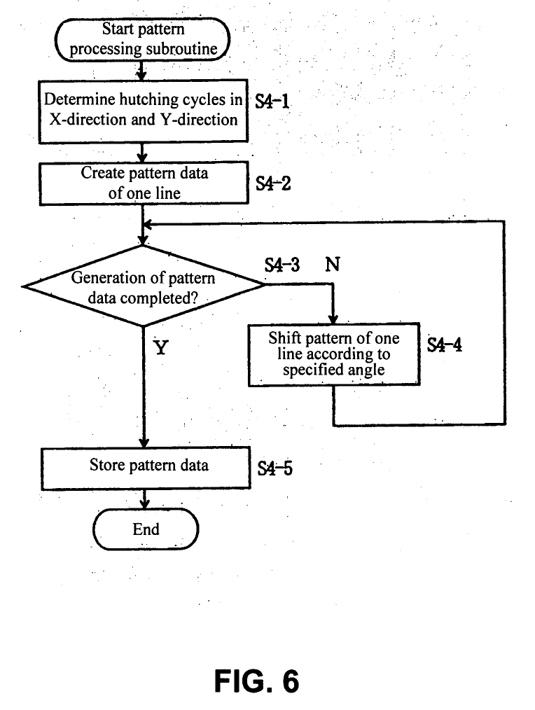

FIG. 5 is a flow chart showing an operation of the data editing unit 23 and the data deploying unit 24 according to the first embodiment of the present invention. FIG. 6 is a flow chart showing a subroutine of the pattern processing according to the first embodiment of the present invention.

First, the host device 10 sends the print data to the printing apparatus 20. Accordingly, the data receiving unit 21 of the printing apparatus 20 receives the print data, and sends the print data thus received to the job control unit 22. Then, the job control unit 22 requests the data editing unit 23 to analyze the print data thus received.

An operation of the data editing unit 23 and the data deploying unit 24 will be explained next. First, the data analyzing section 23a determines whether all of the print data thus received are analyzed. When all of the print data thus received are not analyzed, the data analyzing section 23a reads the print data per command.

In the next step, the data analyzing section 23a determines whether a command included in the print data is a hatching specifying command. When the command is the hatching specifying command, the hatching pattern analyzing section 23b performs pattern processing of hatching according to a hatching angle, an interval between lines, and a line width specified by the hatching specifying command. When the command is not the hatching specifying command, the data analyzing section 23a performs drawing command analysis processing per command, and stores an analysis result into the analysis result storage section 23c.

The hatching specifying command specifies only hatching, and another command such as a graphic fill-out command requests hatching processing. Upon receiving the graphic fill-out command, the pattern processing of hatching is performed according to a hatching angle, an interval between lines, and a line width. The command may include FT▴Option1▴Option 2, PW▴Option3, and the likes, in which Option1 specifies the interval between lines (in a X-direction), Option2 specifies the hatching angle (clockwise from the X-direction), and Option3 specifies the line width.

When the hatching pattern analyzing section 23b starts the pattern processing, the hatching pattern analyzing section 23b first determines a hatching cycle in each of the X-direction and a Y-direction. In this case, the cycle in the X-direction is determined through the line interval, and the cycle in the Y-direction is determined through the line interval and the line angle.

As shown in FIG. 3(a), a lower left corner of a sheet becomes a standard point (default point is the lower left corner of a printable area, and the standard point can be changed). When hatching is applied to a whole area of the sheet (more specifically, a whole area of the printable area), one cycle is defined as a distance from a start point of a line passing through the standard point to a start of a next line.

In the next step, the hatching pattern analyzing section 23b generates pattern data of one line having a length equal to the cycle in the X-direction (one line shown in FIG. 3(b)). At this time, in monochrome printing, a bit on the line is 1 and a bit in other area is 0.

In the next step, the hatching pattern analyzing section 23b determines whether the generation of the pattern data is completed. When the generation of the pattern data is not completed, the hatching pattern analyzing section 23b generates pattern data in which a second line shifted by the specified line angle is created. By repeating this process, the pattern data shown in FIG. 3(b) is created. When the generation of the pattern data is completed, the hatching pattern analyzing section 23b stores the pattern data thus created into the analysis result storage section 23c. Accordingly, it is possible to obtain the hatching pattern shown in FIG. 4(b).

In the next step, the hatching pattern analyzing section 23b determines whether the analysis of all of the pattern data is completed. When the analysis of all of the pattern data is not completed, the process described above is repeated until the analysis of all of the pattern data is completed. When the analysis of all of the pattern data is completed, the data deploying unit 24 receives the analysis result of the print data and the pattern data of hatching from the analysis result storage section 23c to create print image data.

A portion of hatching is deployed using the pattern data through the following process. First, the hatching pattern created through the pattern processing is laid out in a graphic to cover a whole area thereof as shown in FIG. 4(c). At this time, as shown in FIG. 4(d), the hatching pattern is arranged such that the lower left corner of the sheet becomes the standard point.

In the next step, as shown in FIG. 4(e), the graphic shown in FIG. 4(a) is placed over the hatching patterns thus laid out. A portion outside the graphic is ignored, and only a portion inside the graphic is created as the print image data. The outside portion and inside portion of the graphic are determined through an arrangement address of the graphic and a read address of the hatching pattern. A gray area shown in FIG. 4(e) is the outside portion of the graphic thus ignored.

Accordingly, as shown in FIG. 4(f), it is possible to obtain the graphic with the hatching patterns in which the lines are appropriately processed along the borderline of the graphic. Lastly, the print image data is sent to the print control unit 25, thereby performing the printing operation.

The flow charts shown in FIGS. 5 and 6 will be explained next. The operation of the data editing unit 23 and the data deploying unit 24 as a whole will be explained first.

In step S1, it is determined whether the analysis of all of the print data is completed. When the analysis of all of the print data is completed, the process proceeds to step S7. When the analysis of all of the print data is not completed, the process proceeds to step S2.

In step S2, the print data is read. In step S3, it is determined whether the command is the hatching specifying command. When the command is the hatching specifying command, the process proceeds to step S4. When the command is not the hatching specifying command, the process proceeds to step S5.

In step S4, the pattern processing is performed. In step 5, the drawing command analysis processing is performed. In step S6, the analysis result is stored in the analysis result storage section 23c. In step S7, the print image data is created. In step S8, the printing operation is performed, thereby completing the process.

A subroutine of the pattern processing will be explained next. In step S4-1, the hatching cycles in the X-direction and Y-direction are determined. In step S4-2, the pattern data of one line is created. In step S4-3, it is determined whether the generation of the pattern data is completed. When the generation of the pattern data is completed, the process proceeds to step S4-5. When the generation of the pattern data is not completed, the process proceeds to step S4-4.

In step S4-4, the pattern of one line is shifted according to the specified angle. In step S4-5, the pattern data thus created is stored in the analysis result storage section 23c, thereby completing the process.

As described above, when the image processing apparatus draws the hatching lines, the pattern data is used. Accordingly, it is possible to draw the hatching lines along the boundary of the graphic without ends of the hatching lines running over or running short with respect to the boundary of the graphic at the crossing points of the hatching lines.

### Second Embodiment

A second embodiment of the present invention will be explained. Components in the second embodiment similar to those in the first embodiment are designated by the same reference numerals, and explanations thereof are omitted. The components and operations in the second embodiment similar to those in the first embodiment provide effects same as those in the first embodiment, and explanations thereof are omitted.

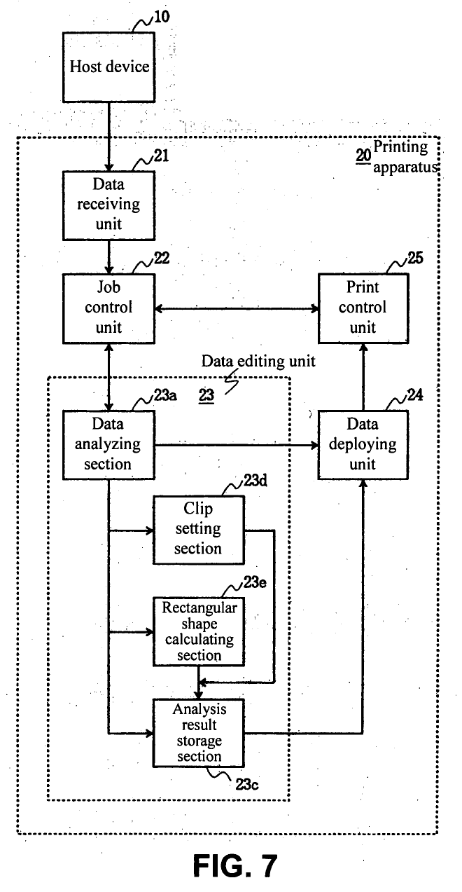

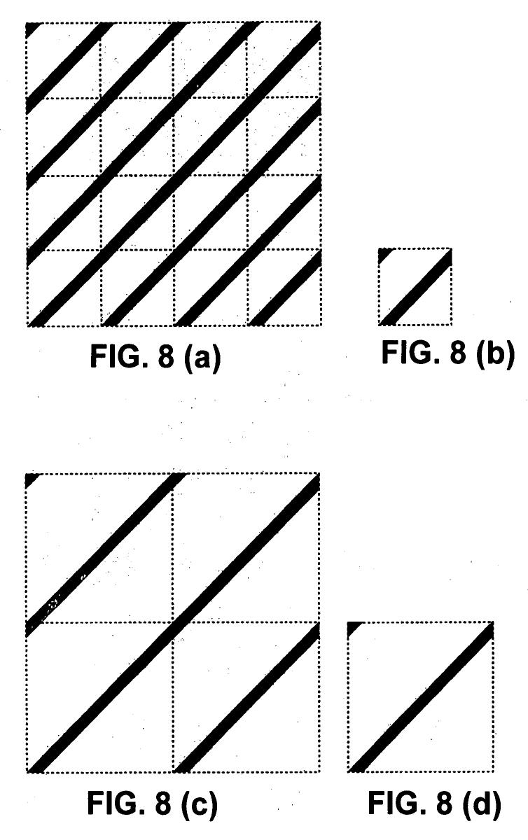

FIG. 7 is a block diagram showing a configuration of an image processing apparatus according to a second embodiment of the present invention. FIGS. 8(a) to 8(d) are views showing comparative examples of hatching lines. FIG. 8(a) is a view showing a first comparative example of the hatching lines, and FIG. 8(b) is a view showing a pattern to be created in the first comparative example. FIG. 8(c) is a view showing a second comparative example of the hatching lines, and FIG. 8(d) is a view showing a pattern to be created in the second comparative example.

As described above in the first embodiment, it is possible to draw the hatching lines along the boundary of the graphic. When a size of pattern data through specifying hatching is changed and an interval between the hatching lines increases, however, the size of the pattern data increases proportionally as shown in FIGS. 8(a) to 8(d).

In particular, when the hatching pattern shown in FIG. 8(a) is applied, the pattern data shown in FIG. 8(b) is created. When the interval between the hatching lines increases twofold as shown in FIG. 8(c), the size of the pattern data increases fourfold as shown in FIG. 8(d), in which a vertical size increases twofold and a horizontal size increases twofold.

In the second embodiment, when hatching is applied, hatching lines are processed along a boundary of a graphic without using pattern data. As shown in FIG. 7, the data editing unit 23 of the printing apparatus 20 includes a clip setting section 23d as a clip processing section and a rectangular shape calculating section 23e as a first rectangular shape calculating section and a second rectangular shape calculating section.

In the embodiment, the clip setting section 23d sets an area of a clip having a rectangular shape, a polygonal shape, and a shape other than rectangular such as a circular shape. The rectangular shape calculating section 23e calculates a rectangular shape in which a graphic to be hutched is accommodated.

Note that the data editing unit 23 in the second embodiment does not include the hatching pattern analyzing section 23b. Other configuration in the second embodiment is the same as that in the first embodiment, and explanation thereof is omitted.

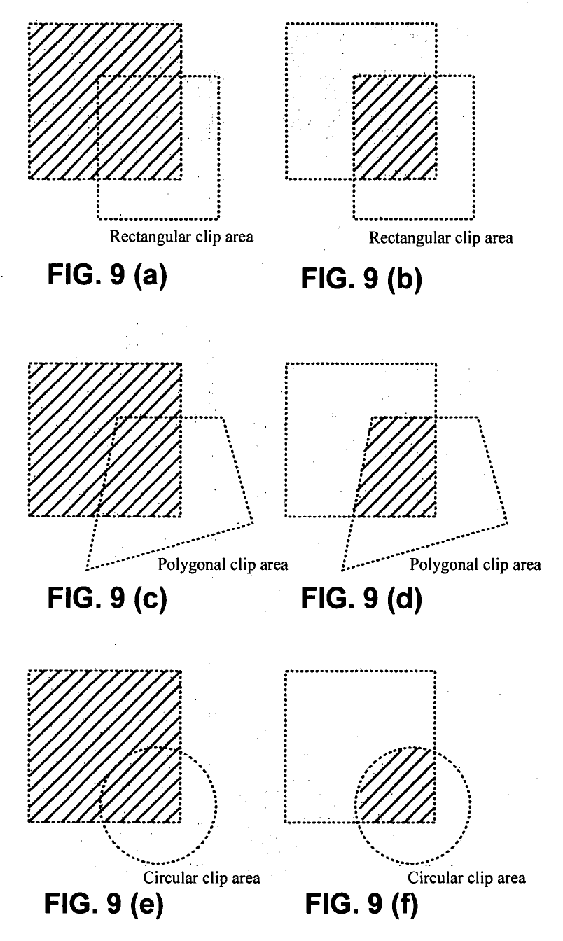

The clip will be explained next. FIGS. 9(a) and 9(d) are schematic views showing the clips according to the second embodiment of the present invention. FIG. 9(a) is a view showing an example of a rectangular clip, and FIG. 9(b) is a view showing a print result of the rectangular clip. FIG. 9(c) is a view showing an example of a polygonal clip, and FIG. 9(d) is a view showing a print result of the polygonal clip. FIG. 9(e) is a view showing an example of a circular clip, and FIG. 9(f) is a view showing a print result of the circular clip.

When a graphic to be drawn and a rectangular clip area are set as shown in FIG. 9(a), an overlapped portion of the graphic and the rectangular clip is printed as shown in FIG. 9(b). When a graphic to be drawn and a polygonal clip area are set as shown in FIG. 9(c), an overlapped portion of the graphic and the polygonal clip is printed as shown in FIG. 9(d). When a graphic to be drawn and a circular clip area are set as shown in FIG. 9(e), an overlapped portion of the graphic and the circular clip is printed as shown in FIG. 9(f).

Accordingly, in the embodiment, it is possible to draw the hatching lines along the boundary of the graphic through the hatching and clip function.

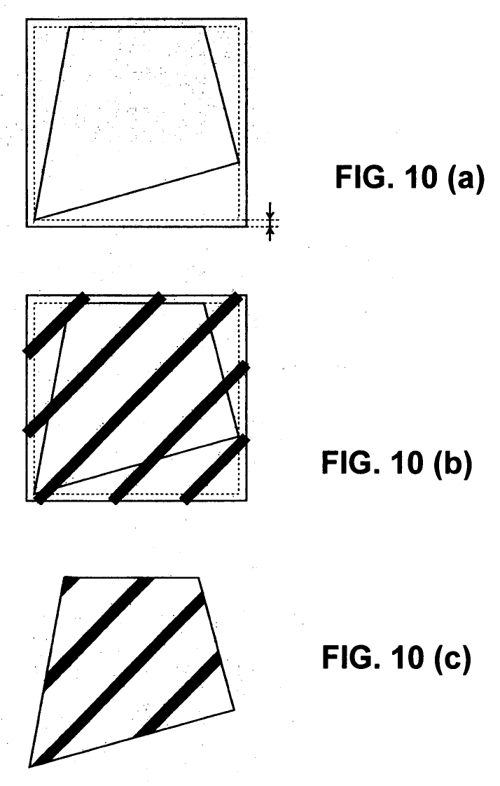

An operation of the printing apparatus 20 will be explained next. First, an operation of the data editing unit 23 and the data deploying unit 24 will be explained. FIGS. 10(a) to 10(c) are views showing an example of the hatching lines using the graphic as the clip according to the second embodiment of the present invention. FIG. 10(a) is a view showing a rectangular shape in which the graphic is accommodated. FIG. 10(b) is a view showing a state that hatching is applied to the rectangular shape. FIG. 10(c) is a view showing a print result after hatching is applied.

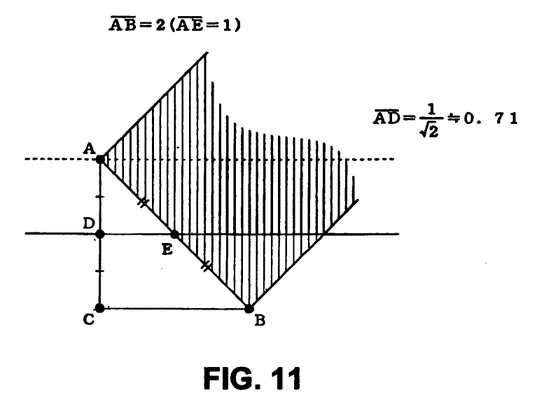

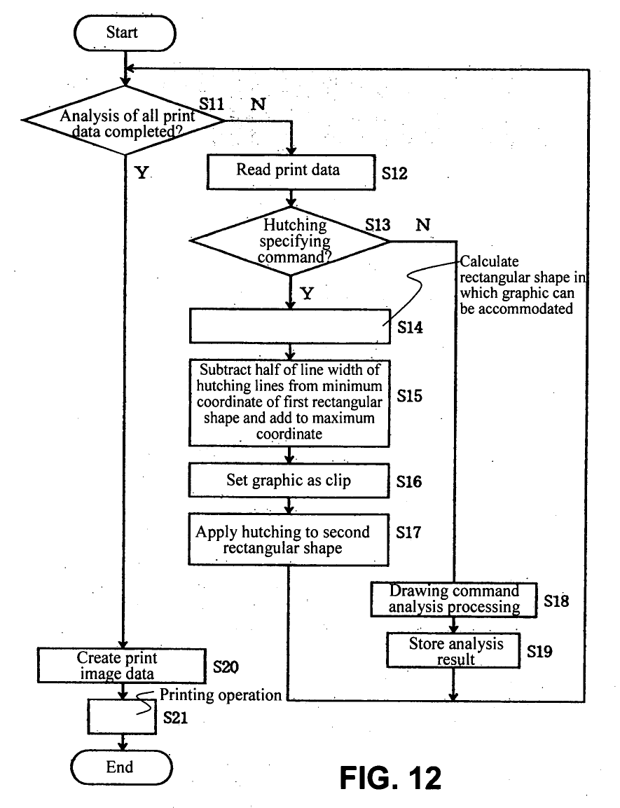

FIG. 11 is a view showing a method of determining a size of a rectangle according to the second embodiment of the present invention. FIG. 12 is a flow chart showing an operation of a data editing unit and a data deploying unit according to the second embodiment of the present invention.

First, the data analyzing section 23a determines whether all of the print data thus received are analyzed. When all of the print data thus received are not analyzed, the data analyzing section 23a reads the print data per command.

In the next step, the data analyzing section 23a determines whether a command included in the print data is the hatching specifying command. When the command is the hatching specifying command, the rectangular shape calculating section 23e calculates the rectangular shape in which the graphic can be accommodated as shown in FIG. 10(a). In this case, the rectangular shape calculating section 23e compares coordinates of corners of the graphic to determine a maximum coordinate (x, y) and a minimum coordinate (x, y), thereby obtaining a first rectangular shape having the maximum and minimum coordinates at corners thereof.

In the next step, hatching is applied to the first rectangular shape. In this case, if the graphic has a common side with respect to the rectangular shape, ends of hatching lines run short within the graphic. When it is the case, a half of a line width of the hatching lines is subtracted from the minimum coordinate of the first rectangular shape and added to the maximum coordinate of the first rectangular shape, thereby obtaining a second rectangular shape. Through this process, the first rectangular shape is expanded in horizontal and vertical directions by the half of the line width.

In the embodiment, the first rectangular shape is enlarged by the half of the line width. Alternatively, an increment may be calculated according to the line width and the line angle as shown in FIG. 11. In FIG. 11, when the line width is 2.0 cm and the line angle is 45 degrees, the increment is calculated to be 0.71.

In the next step, the clip setting section 23d sets the graphic to which hatching is applied as the clip. Then, as shown in FIG. 10(b), hatching is applied to the second rectangular shape thus calculated. In this case, crossing points between the hatching lines and the boundary of the graphic are calculated, so that lines between the crossing points become centerlines of the hatching lines. Then, the hatching lines are enlarged in a direction perpendicular to the centerlines, thereby making it possible to draw the hatching lines having the enlarged line width. At this time, a portion outside the graphic is ignored upon deploying. Accordingly, it is possible to apply hatching along the boundary of the graphic as shown in FIG. 10(c).

In determining whether the command included in the print data is the hatching specifying command, when the command is not the hatching specifying command, the data analyzing section 23a performs drawing command analysis processing per command, and stores an analysis result into the analysis result storage section 23c.

In the next step, the hatching pattern analyzing section 23b determines whether the analysis of all of the pattern data is completed. When the analysis of all of the pattern data is not completed, the process described above is repeated until the analysis of all of the pattern data is completed. When the analysis of all of the pattern data is completed, the data deploying unit 24 receives the analysis result of the print data and the pattern data of hatching from the analysis result storage section 23c to create print image data. Lastly, the print image data is sent to the print control unit 25, thereby performing the printing operation.

The flow chart shown in FIG. 12 will be explained next. In step S11, it is determined whether the analysis of all of the print data is completed. When the analysis of all of the print data is completed, the process proceeds to step S20. When the analysis of all of the print data is not completed, the process proceeds to step S12.

In step S12, the print data is read. In step S13, it is determined whether the command is the hatching specifying command. When the command is the hatching specifying command, the process proceeds to step S14. When the command is not the hatching specifying command, the process proceeds to step S18.

In step S14, the rectangular shape in which the graphic can be accommodated is calculated. In step S15, the half of the line width of the hatching lines is subtracted from the minimum coordinate of the first rectangular shape and added to the maximum coordinate of the first rectangular shape. In step S16, the graphic is set as the clip. In step S17, hatching is applied to the second rectangular shape.

In step S18, the drawing command analysis processing is performed. In step S19, the analysis result is stored in the analysis result storage section 23c. In step S20, the print image data is created. In step S21, the printing operation is performed, thereby completing the process.

As described above, in the second embodiment, it is possible to apply hatching along the boundary of the graphic. Further, as compared with the first embodiment, it is possible to reduce a usage amount of the storage area.

In the first and second embodiments, the present invention is applied to the printing apparatus 20, and is applicable to an MFP (Multi Function Printer), a facsimile, a copier, and any types of image forming apparatus. Further, the present invention is applicable to a general graphics drawing engine (application running on a computer) that draws upon receiving a command.

The disclosure of Japanese Patent Application No. 2006-066885, filed on Mar. 13, 2006, is incorporated in the application.

While the invention has been explained with reference to the specific embodiments of the invention, the explanation is illustrative and the invention is limited only by the appended claims.

What is claimed is:

1. An image processing apparatus, comprising:
a data analyzing unit for analyzing image data including graphic data and hatching specifying data to detect the graphic data and the hatching specifying data;
a first rectangular shape setting section for setting a first rectangular shape greater than the graphic data and accommodating the graphic data according to the graphic data;
a hatching processing unit for applying hatching to the first rectangular shape according to the hatching specifying data; and
a clip processing unit for clipping the first rectangular shape with the hatching applied by the hatching processing unit according to the graphic data.

2. The image processing apparatus according to claim 1, wherein said first rectangular shape corresponds to a whole printable area of a page.

3. The image processing apparatus according to claim 1, further comprising a receiving unit for receiving image data including the graphic data and the hatching specifying data.

4. The image processing apparatus according to claim 1, further comprising a pattern forming unit for forming a hatching pattern according to the hatching specifying data when the data analyzing unit detects the hatching specifying data.

5. The image processing apparatus according to claim 4, further comprising a pattern arranging unit for arranging the hatching pattern with respect to a standard point.

6. The image processing apparatus according to claim 5, wherein said clip processing unit clips the hatching pattern arranged by the pattern arranging unit according to the image data.

7. The image processing apparatus according to claim 4, wherein said pattern forming unit forms the hatching pattern according to a line angle, an interval between lines and a line width specified in the hatching specifying data.

8. The image processing apparatus according to claim 5, wherein said pattern arranging unit arranges the hatching pattern with respect to the standard point located in a printable area of a sheet.

9. The image processing apparatus according to claim 8, wherein said pattern arranging unit arranges the hatching pattern with respect to the standard point located at a lower left corner of a sheet.

10. The image processing apparatus according to claim 8, wherein said pattern arranging unit arranges the hatching pattern with respect to the standard point that is adjustable.

11. The image processing apparatus according to claim 1, wherein said first rectangular shape setting section sets the first rectangular shape such that the first rectangular shape is greater than the graphic data in a vertical direction and a lateral direction by a specific length.

12. The image processing apparatus according to claim 11, further comprising a receiving unit for receiving image data including the graphic data and the hatching specifying data.

13. The image processing apparatus according to claim 12, wherein said receiving unit receives the hatching specifying data including line width specifying data so that the second rectangular shape calculating section enlarges the first rectangular shape by a half of a line width.

14. The image processing apparatus according to claim 12, wherein said receiving unit receives the hatching specifying data including line width specifying data and line angle specifying data so that the first rectangular shape is greater than the graphic data according to the line width specifying data and the line angle specifying data.
